(19) United States
(12) Patent Application Publication
(10) Pub. No.: US 2024/0397521 A1
(43) Pub. Date: Nov. 28, 2024

(54) RANDOM ACCESS PROCEDURE TECHNIQUES

(71) Applicant: ZTE Corporation, Shenzhen (CN)

(72) Inventors: Xiaolong GUO, Shenzhen (CN); Bo GAO, Shenzhen (CN); Yang ZHANG, Shenzhen (CN); Ling YANG, Shenzhen (CN); Ke YAO, Shenzhen (CN)

(21) Appl. No.: 18/679,266

(22) Filed: May 30, 2024

Related U.S. Application Data
(63) Continuation of application No. PCT/CN2023/086374, filed on Apr. 5, 2023.

(51) Int. Cl. H04W 72/231; H04B 7/06; H04L 1/00; H04W 72/1273; H04W 74/0833

(52) U.S. Cl. CPC H04W 72/231; H04B 7/06968; H04L 1/0061; H04W 72/1273; H04W 74/0833

(57) ABSTRACT

Techniques are described to perform random access. An example wireless communication method includes receiving, by a communication device, a control information format that indicates to initiate a random access procedure associated with a transmission parameter; performing, by the communication device and in response to the receiving the control information format, a random access channel (RACH) transmission; receiving, in response to the RACH transmission, a control channel with a cyclic redundancy check (CRC) scrambled by a radio network temporary identifier (RNTI), where the RNTI is associated with the RACH transmission; and receiving, by the communication device, a shared channel scheduled by the RNTI, where the control channel and the shared channel are received during a random access response window that is defined according to a rule.

### CROSS-REFERENCE TO RELATED APPLICATION

This application is a continuation and claims priority to International Application No. PCT/CN2023/086374, filed on Apr. 5, 2023, the disclosure of which is hereby incorporated by reference herein in its entirety.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for random access procedure such as when a random access procedure is triggered by a downlink control information (DCI) format for a physical downlink control channel (PDCCH) order. Some example techniques include a user equipment (UE) determining random access response window, the UE determining quasi co-location properties, the UE determining PRACH transmission power when random access response (RAR) is not received, the UE determining cell-radio network temporary identifier (C-RNTI) based on messages from network, and/or the UE determining when and/or how to drop timing advance values.

A first wireless communication method includes receiving, by a communication device, a control information format that indicates to initiate a random access procedure associated with a transmission parameter; performing, by the communication device and in response to the receiving the control information format, a random access channel (RACH) transmission; receiving, in response to the RACH transmission, a control channel with a cyclic redundancy check (CRC) scrambled by a radio network temporary identifier (RNTI), where the RNTI is associated with the RACH transmission; and receiving, by the communication device, a shared channel scheduled by the RNTI, where the control channel and the shared channel are received during a random access response window that is defined according to a rule.

In some embodiments, the rule specifies that the random access response window starts at a symbol based on any one or more of: (1) a first symbol of an earliest control resource set (CORESET) that the communication device is configured to receive the control channel for a Type1-PDCCH common search space (CSS) set, where the Type1-PDCCH CSS set is configured for a serving cell or for the transmission parameter, (2) an offset value for the transmission parameter, where the offset value indicates a number of symbols or a number of slots, (3) an indication field of the control information format for a physical downlink control channel (PDCCH) order that triggers the random access procedure, where the indication field indicates a number of milliseconds, a number of symbols, or a number of slots, or (4) a first symbol or a last symbol of the RACH transmission. In some embodiments, the rule specifies that a length of the random access response window is based on any one or more of: (1) another length of the random access response window configured for a serving cell or for a corresponding transmission parameter, (2) an offset value for the transmission parameter, where the offset value indicates a number of milliseconds, (3) an indication field of the control information format for a physical downlink control channel (PDCCH) order that triggers the random access procedure, where the indication field indicates a number of milliseconds.

In some embodiments, the rule specifies that the random access response window is based on: a configured set of values or a combination of values associated with a starting point of the random access response window and/or a length of the random access response window, where the configured set of values are configured by a radio resource control (RRC) message, a codepoint of an indication field of the control information format for a physical downlink control channel (PDCCH) order that triggers the random access procedure, where the codepoint is mapped to a value or a combination of values within the configured set of values. In some embodiments, the control information format includes a downlink control information (DCI) format, where the control channel is a physical downlink control channel (PDCCH), and where the shared channel is a physical downlink shared channel (PDSCH).

In some embodiments, the method further comprises receiving, by the communication device, a physical downlink control channel (PDCCH) order associated with a first transmission parameter using a first quasi co-location (QCL) property of a reference signal port; receiving, by the communication device, a channel using a second QCL property of the reference signal port in response to at least one of: (1) a first information or a first identity of the first transmission parameter to receive the PDCCH order being different than a second information or a second identity of a second transmission parameter indicated by an indication field in the PDCCH order, or (2) the first information or the first identity of the first transmission parameter to receive the PDCCH order being different than a third information or a third identity of the transmission parameter to receive the channel. In some embodiments, the second QCL property of the reference signal port to receive the channel is same as that of a synchronized signal block (SSB) or a channel state information reference signal (CSI-RS) used for the performing the RACH transmission, and where the channel is a physical downlink control channel (PDCCH) scrambled with the RNTI, or the channel is a physical downlink shared channel (PDSCH) scheduled with the RNTI.

In some embodiments, the second QCL property of the reference signal port to receive the channel is same as that of a control resource set (CORESET) associated with a Type-1 physical downlink control channel (PDCCH) common search space (CSS) set, and where the channel is a physical downlink control channel (PDCCH) scrambled with the RNTI. In some embodiments, the second QCL property of the reference signal port to receive the channel is same as that of a physical downlink control channel (PDCCH) scrambled with the RNTI, and where the channel is a physical downlink shared channel (PDSCH) scheduled with the RNTI. In some embodiments, the reference signal port includes a demodulation reference signal (DM-RS) port. In some embodiments, the method further comprises receiving, by the communication device, a physical downlink control channel (PDCCH) order associated with a first transmission parameter using a first quasi co-location (QCL) property of a reference signal port; receiving, by the communication device, a channel using a second QCL property of the reference signal port in response to at least one of: (1) a first information or a first identity of the first transmission parameter to receive the PDCCH order being different than a second information or a second identity of a second transmission parameter indicated by an indication field in the PDCCH order, or (2) the first information or the first identity of the first transmission parameter to receive the PDCCH order being same as a third information or a third identity of the transmission parameter to receive the channel.

In some embodiments, the second QCL property of the reference signal port to receive the channel is same as that of a control resource set (CORESET) associated with a Type-1 physical downlink control channel (PDCCH) common search space (CSS) set, and where the channel is a physical downlink control channel (PDCCH) scrambled with the RNTI. In some embodiments, the second QCL property of the reference signal port to receive the channel is same as that of a physical downlink control channel (PDCCH) scrambled with the RNTI, and where the channel is a physical downlink shared channel (PDSCH) scheduled with the RNTI. In some embodiments, the second QCL property of the reference signal port to receive the channel is same as that of a control resource set (CORESET) associated with the receiving the PDCCH order, and where the channel is a physical downlink shared channel (PDSCH) scrambled with the RNTI.

In some embodiments, the reference signal port includes a demodulation reference signal (DM-RS) port. In some embodiments, the method further comprises receiving, by the communication device, a configuration or an indication to receive or not to receive a random access response (RAR); and performing, in response to the receiving the configuration or the indication, any one or more of following operations: a random access procedure in response to a transmission of a random access preamble is determined to be completed, the random access response window is not started by a medium access control (MAC) entity of the communication device, or a physical downlink control channel (PDCCH) is not monitored by the MAC entity for the RAR identified by a corresponding RNTI.

In some embodiments, the method further comprises adjusting, in response to the receiving the control information format that indicates to initiate the random access procedure, a random access channel (RACH) target received power or a power with which the RACH transmission is performed during the random access procedure, where the adjusting is performed based on at least one of: (1) a fixed power adjustment parameter, a predefined power adjustment parameter, or a configured power adjustment parameter, or (2) an indication field included in the control information format, where the indication field indicates a counting indication, a toggle flag or a power control command. In some embodiments, further comprises receiving, by the communication device, a cell switch command message or a random access response (RAR) that includes an indication field indicative of a second RNTI; and performing, by the communication device, a transmission or a reception by: applying the second RNTI that is indicated in the indication field, applying the second RNTI based on an offset value indicated in the indication field, where the offset value is related to the second RNTI, or applying the second RNTI associated with the transmission parameter indicated in the indication field.

In some embodiments, configuration related to an association between the second RNTI and the transmission parameter is received by the communication device. In some embodiments, the second RNTI is a cell radio network temporary identifier (C-RNTI) or a temporary cell radio network temporary identifier (TC-RNTI). In some embodiments, the method further comprises receiving, by the communication device, a timing advance related message that is associated with the transmission parameter based on a reception of a random access response (RAR); determining, by the communication device, a timing advance (TA) value associated with the transmission parameter. In some embodiments, the method further comprises receiving, by the communication device, a medium access control-control element (MAC CE) that indicates a plurality of transmission parameters, where a first total number of the plurality of transmission parameters or a second total number of one or more unique transmission parameters in the plurality of transmission parameters is less than or equal to a total number of TA values that the communication device is capable of storing; and storing, by the communication device, the TA value associated with the transmission parameters indicated by the MAC CE.

In some embodiments, the method further comprises receiving, by the communication device, a deactivation medium access control-control element (MAC CE) that indicates one or more transmission parameters to be deactivated; and deleting, in response to the receiving the deactivation MAC CE, one or more TA values associated with the one or more transmission parameters. In some embodiments, the method further comprises performing TA related operations in response to: a number of TA values stored in the communication device being equal to a total number of TA values that the communication device is capable of storing, and a timing advance (TA) value for the transmission parameter is not stored by the communication device, where the TA related operations includes: deleting a second TA value stored in the communication device at an earliest time relative to one or more other TA values stored in the communication device; and storing, after the deleting, the TA value.

In some embodiments, the transmission parameter comprises any one or more of: information grouping one or more reference signals, a reference signal resource set, a physical uplink control channel (PUCCH) resource set, a search space, a panel related information, a sub-array, an antenna group, an antenna port group, a group of antenna ports, a beam group, a physical cell index (PCI), a transmit-receive point (TRP) related information, a control resource set (CORESET), a CORESET pool, a transmission configuration indicator (TCI) state, a serving cell, an additional PCI, a candidate cell, a candidate cell group, a timing advance group (TAG), a UE capability value, or a UE capability set.

A second wireless communication method includes transmitting, by a network device, a control information format that indicates to a communication device to initiate a random access procedure associated with a transmission parameter; receiving, by the network device and in response to the transmitting the control information format, a random access channel (RACH) transmission; transmitting, in response to the receiving the RACH transmission, a control channel with a cyclic redundancy check (CRC) scrambled by a radio network temporary identifier (RNTI), where the RNTI is associated with the RACH transmission; and transmitting, by the network device, a shared channel scheduled by the RNTI.

In some embodiments, the control information format includes an indication field to indicate to the communication device to adjust a random access channel (RACH) target received power or a power with which the RACH transmission is performed during the random access procedure, where the indication field indicates a counting indication, a toggle flag or a power control command. In some embodiments, the method further comprises transmitting, by the network device, a cell switch command message or a random access response (RAR) that includes an indication field indicative of a second RNTI. In some embodiments, configuration related to an association between the second RNTI and the transmission parameter is transmitted by the network device. In some embodiments, the second RNTI is a cell radio network temporary identifier (C-RNTI) or a temporary cell radio network temporary identifier (TC-RNTI).

In some embodiments, the method further comprises transmitting, by the network device, a timing advance related message that is associated with the transmission parameter based on a transmission of a random access response (RAR). In some embodiments, the method further comprises transmitting, by the network device, a medium access control-control element (MAC CE) that indicates a plurality of transmission parameters, where a first total number of the plurality of transmission parameters or a second total number of one or more unique transmission parameters in the plurality of transmission parameters is less than or equal to a total number of TA values that the communication device is capable of storing. In some embodiments, the method further comprises transmitting, by the network device, a deactivation medium access control-control element (MAC CE) that indicates one or more transmission parameters to be deactivated. In some embodiments, the transmission parameter comprises any one or more of: information grouping one or more reference signals, a reference signal resource set, a physical uplink control channel (PUCCH) resource set, a search space, a panel related information, a sub-array, an antenna group, an antenna port group, a group of antenna ports, a beam group, a physical cell index (PCI), a transmit-receive point (TRP) related information, a control resource set (CORESET), a CORESET pool, a transmission configuration indicator (TCI) state, a serving cell, an additional PCI, a candidate cell, a candidate cell group, a timing advance group (TAG), a UE capability value, or a UE capability set.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example flowchart for defining or determining a random access response window.

FIG. 2 shows an example flowchart for transmitting channel(s) during a random access procedure.

FIG. 3 shows an example block diagram of a hardware platform that may be a part of a network device or a communication device.

FIG. 4 shows an example of wireless communication including a base station (BS) and user equipment (UE) based on some implementations of the disclosed technology.

### DETAILED DESCRIPTION

For wireless communication scenarios involving Multiple Transmit-Receive Points (MTRP) transmission and Layer 1&2 triggered inter-cell mobility, the acquisition of respective timing advance (TA) values for multiple transmit-receive points (TRPs) or physical cells may be required. Random access procedure triggered by physical downlink control channel (PDCCH) order can be initiated to acquire TA value, and when the PDCCH order is received by the user equipment (UE), the following should be considered by the UE: physical random access channel (PRACH) transmission and random access response (RAR) reception associated with different TRPs or cells, the quasi co-location (QCL) properties for PDCCH/physical downlink shared channel (PDSCH) associated with the random access procedure, the steps of random access procedure, and/or transmission power of PRACH transmission. In this patent document, the term “PDCCH order” is received by the UE when the UE receives a specific DCI format, so that when the UE receives the specific DCI format that indicates PDCCH order the UE is triggered to perform random access procedure (e.g., contention free random access procedure).

The following is a summary of the techniques described in the embodiments of this patent document:
(1) In response to PRACH transmission, UE may monitor PDCCH scrambled by RA-RNTI/MSGB-RNTI within the random access response window. In case that PRACH is transmitted to one TRP/cell and RAR is received from another TRP/cell, the time gap or delay between PRACH transmission and RAR reception can be larger. For UE power saving and UE complexity reduction, mechanisms to configure/indicate a larger length of the random access response window to detect PDCCH or to additionally specify starting point of random access response window are considered as follows.
   UE may receive configuration including length of random access response window, and/or an offset value of random access response window for a transmission parameter.
      UE may determine a new stating point of random access response window and detects/monitors PDCCH within the random access response window.
(2) In response to PRACH transmission, UE may detect PDCCH scrambled by RA-RNTI/MSGB-RNTI and further decodes PDSCH corresponds to the PDCCH based on the DM-RS antenna port QCL properties. Due to the information/identity of transmission parameter for detecting/receiving the PDCCH order and the information/identity of transmission parameter indicated by the PDCCH order can be different, and/or the information/identity of transmission parameter for detecting/receiving the PDCCH scrambled by the corresponding RA-RNTI/MSGB-RNTI and the information/identity of transmission parameter for detecting/receiving the PDCCH order can be different, the QCL properties should be considered.
(3) UE may determine transmission power of PRACH transmission based on preamble received target power and calculated pathloss of a DL-RS. For legacy random access procedure, power ramping mechanism is used to adjust PRACH transmission power when RAR is not received by UE within the random access response window. When UE is configured/indicated to not receive RAR, power ramping mechanism is invalid. New mechanism to adjust PRACH transmission power is considered as follows:
   For PRACH transmission in response to a random access procedure initiated by a PDCCH order, UE may determine to adjust preamble received target power or to adjust transmission power of the PRACH transmission.
      The power adjustment is based on counting mechanism, e.g., COUNTER increases 1 at every reception of PDCCH order or every initiation of PRACH transmission associated with a transmission parameter.
      The power adjustment is based on indication field(s) in PDCCH order, e.g., an indication field can indicate UE to adjust transmission power.
(4) UE may receive a message from base station, where the message may include:
   An indication field is included in the message to indicate to the UE to update/replace/change the C-RNTI of UE.
      If the indication field is absent or is indicted as a specific value, C-RNTI of the UE is unchanged, otherwise UE updates the C-RNTI.
         The indication field can explicit indicate the C-RNTI.
         The indication field can indicate an information/identity of a transmission parameter, and C-RNTI is configured to be associated with the transmission parameter.
(5) UE may memorize/store/maintain/restore TA value(s) in response to UE reporting a UE capability of the maximum number of memorized TA values.
   UE may drop/delete/invalidate/clear a most remotely/earliest memorized timing advance value associated with a transmission parameter.
   UE may receive a transmission parameter activation MAC CE wherein a plurality of transmission parameters are mapped/included/indicated. UE may not initiate random access procedures and/or maintain timing advance values associated with the transmission parameters not included in the MAC CE.
   UE may receive a transmission parameter deactivation MAC CE wherein a plurality of transmission parameters are mapped/included/indicated. UE may drop the memorized timing advance values associated with the transmission parameters included in the MAC CE.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. INTRODUCTION

Downlink and uplink synchronization provide reliable wireless communication in LTE and NR wireless system. The downlink synchronization is realized by receiving primary synchronization signal (PSS) and secondary synchronization signal (SSS), and the uplink synchronization is realized by random access procedure and uplink timing alignment maintenance. The random access procedure can be initiated for initial access, system information (SI) request, beam failure recovery, timing alignment and so on.

Prior to the initiation of a random access procedure, UE receives configuration of RACH resource and a set of SS/PBCH blocks. For a typical contention free random access procedure triggered by PDCCH order, UE transmits preamble in the RACH occasion determined based on indication fields in PDCCH order, and then detects PDCCH scrambled by RA-RNTI/MSGB-RNTI associated with the preamble transmission within the random access response window. If PDCCH is not detected and/or the corresponding PDSCH is not received within the random access response window, preamble/PRACH will be re-transmitted. RAR is carried in PDSCH scheduled by the PDCCCH scrambled by RA-RNTI/MSGB-RNTI, and at least includes Timing Advance Command (TAC). UE can determine timing advance values for uplink transmissions according to the Timing Advance Command.

Due to different geographical locations of base stations or different beam directions of panels at base station side, timing advance required for uplink transmissions towards different cells can be diverse. Individual random access procedures towards different TRPs/cells to acquire timing advance value are required.

The configuration of RACH resource comprises at least one of an index of PRACH configuration, a number of preambles, the number of SSB mapped in a PRACH occasion, the number of preambles for a SSB, or the number of frequency division multiplexed PRACH occasion. The PRACH configuration is predefined in a table, comprising the format of a preamble, the frame or subframe number of a PRACH occasion, the start symbol of a PRACH occasion, and the duration of a PRACH occasion.

### II. EXAMPLE EMBODIMENTS

In this patent document, ‘transmission parameter’ may comprise at least one of transmit-receive point (TRP), base station, a set of panels of one base station, a cell, or a physical cell. Furthermore, the transmission parameter comprises at least one of “information grouping one or more reference signals”, reference signal resource set, PUCCH resource set, search space, panel related information, sub-array, antenna group, antenna port group, group of antenna ports, beam group, physical cell index (PCI), TRP related information, CORESET, CORESET pool, transmission configuration indicator (TCI) state, serving cell, additional PCI, candidate cell, candidate cell group, TAG, “UE capability value” or “UE capability set”.

In this patent document, information/identity of transmission parameter may comprise at least one of CORESET index, CORESET pool index, SS/PBCH index, transmission configuration indicator (TCI) state index, PCI, RS set index, search space identity, SRS resource set index, spatial relation index, power control parameter set index, panel index, beam group index, sub-array index, the index of CDM group of DMRS ports, the group index of CSI-RS resources, CMR set index, TAG index, candidate cell index, or candidate cell lists. In this patent document, “uplink signal” may comprise PUCCH, PUSCH, SRS or PRACH. In this patent document, uplink transmissions may comprise UL-SCH or PUSCH; downlink transmissions may comprise DL-SCH or PDSCH.

In this patent document, “slot” can be equivalent to sub-slot, frame, sub-frame. In this patent document, PRACH occasion may comprise an area specified in time and frequency domain that are available for the transmission of random access preamble. In this patent document, PRACH configuration may comprise at least one of the format of a preamble, the frame or subframe number of a PRACH occasion, the start symbol of a PRACH occasion, the duration of a PRACH occasion, the number of time-domain PRACH occasions within a PRACH slot or the number of PRACH slots in a subframe. In this patent document, a PRACH transmission initiated by a PDCCH order may be equivalent to a PRACH transmission triggered by a PDCCH order or a PRACH transmission associated with a random access procedure initiated/triggered by a PDCCH order. In this patent document the words “memorize” or “memorized” can be the same as “store” or “stored.” In this patent document, the words ‘timing advance related message’ can include/comprise at least one of: a cell index, a time alignment group (TAG) index, a timing advance command, a timing advance offset, and/or a timing advance offset command.

### II. (a) Example Embodiment 1

Embodiment 1 describes example techniques for a UE to monitor PDCCH for random access response within a random access response window in response to a random access procedure associated with a transmission parameter.

UE is configured a length (e.g., a duration or a length of time) of a random access response window for serving cell. In some embodiments, UE is further configured the length of a random access response window associated with a transmission parameter.

In some embodiments, in response to a PRACH transmission associated with a transmission parameter, UE detects DCI format 1_0 with CRC scrambled by the corresponding RA-RNTI/MSGB-RNTI during a random access response window.
The random access response window starts at the symbol determined based on at least one of: (1) the first symbol of the earliest CORESET UE is configured to receive PDCCH for Type1-PDCCH CSS set, wherein the Type1-PDCCH CSS set can be that configured for serving cell or for the corresponding transmission parameter, (2) an offset value UE is configured for a transmission parameter, and the offset value indicates a number of symbols or slots, (3) an indication field of DCI format for PDCCH order, wherein the indication field indicates a number of milliseconds, symbols or slots, (4) the first or last symbol of the corresponding PRACH transmission.
The length of random access response window is determined based on at least one of: (1) the length of random access response window configured for serving cell or for the corresponding transmission parameter, (2) an offset value UE is configured for the transmission parameter, wherein the offset value indicates a number of milliseconds, (3) an indication field of DCI format for PDCCH order, wherein the indication field indicates a number of milliseconds.
In some embodiments, UE is configured a set of values or combinations of values associated with the starting point and/or the length of random access response window by RRC messages. A codepoint of an indication field of DCI format for PDCCH order is mapped to a value or a value combination within the configured set of values.
In some embodiments, UE reports a UE capability of maximum value of the length of random access response window and/or a UE capability of maximum time gap between a PRACH transmission or a CORESET UE is configured to receive PDCCH for Type1-PDCCH CSS set, and the starting point of a random access response window

### II. (b) Example Embodiment 2

Embodiment 2 describes example techniques for a UE to determine DM-RS port quasi co-location properties of PDCCH/PDSCH associated with RA-RNTI/MSGB-RNTI in response to a PRACH transmission initiated by a PDCCH order (or PDCCH order message) that includes or indicates an information/identity of a transmission parameter. For example, a first TRP can transmit to a UE a message that indicates PDCCH order, where the message includes information or identify of a second TRP so that the UE can be triggered to perform random access procedure with the second TRP.

For a PRACH transmission on a PRACH occasion, the corresponding RA-RNTI/MSGB-RNTI is calculated and applied to PDSCH or PDCCH by a base station. In response to a transmission of PRACH, UE detects PDCCH scrambled by the corresponding RA-RNTI/MSGB-RNTI within the random access response window, and further receives PDSCH scheduled with the RA-RNTI/MSGB-RNTI.

In response to a PRACH transmission initiated by a PDCCH order that includes or indicates an information/identity of a transmission parameter, if the information/identity of transmission parameter for detecting/receiving the PDCCH order and the information/identity of transmission parameter indicated by the PDCCH order are different, and/or if the information/identity of transmission parameter for detecting/receiving the PDCCH scrambled by the corresponding RA-RNTI/MSGB-RNTI and the information/identity of transmission parameter for detecting/receiving the PDCCH order are different, then the UE can perform at least one of:
(1) UE determines that the DM-RS port QCL properties of PDCCH scrambled by the corresponding RA-RNTI/MSGB-RNTI is the same as that of the SSB/CSI-RS used for the PRACH association and transmission.
(2) UE determines that the DM-RS port QCL properties of PDSCH scheduled with corresponding RA-RNTI/MSGB-RNTI is the same as that of the SSB/CSI-RS used for the PRACH association and transmission.
(3) UE determines that DM-RS port QCL properties of the PDCCH scrambled by the corresponding RA-RNTI/MSGB-RNTI is the same as that of the CORESET associated with the Type1-PDCCH CSS set.
(4) UE determines that the DM-RS port QCL properties of the PDSCH scheduled with corresponding RA-RNTI/MSGB-RNTI is the same as that of PDCCH scrambled by the corresponding RA-RNTI/MSGB-RNTI.

In response to a PRACH transmission initiated by a PDCCH order that includes or indicates an information/identity of a transmission parameter, if the information/identity of transmission parameter for detecting/receiving the PDCCH order and the information/identity of transmission parameter indicated by the PDCCH order is different, and if the information/identity of transmission parameter for detecting/receiving the PDCCH scrambled by the corresponding RA-RNTI/MSGB-RNTI and the information/identity of transmission parameter for detecting/receiving the PDCCH order is the same, at least one of:
(1) if the PDCCH order triggers CFRA for SpCell, UE determines that the PDCCH order and the PDCCH scrambled by the corresponding RA-RNTI/MSGB-RNTI have same DM-RS port QCL properties;
(2) if the PDCCH order triggers CFRA for SCell, UE determines that DM-RS port QCL properties of the PDCCH scrambled by the corresponding RA-RNTI/MSGB-RNTI is the same as that of the CORESET associated with the Type1-PDCCH CSS set.
(3) UE determines that the DM-RS port QCL properties of the PDSCH scheduled with corresponding RA-RNTI/MSGB-RNTI is the same as that of PDCCH scrambled by the corresponding RA-RNTI/MSGB-RNTI.
(4) if the PDCCH order triggers CFRA for SpCell, UE determines that the DM-RS port QCL properties of the PDSCH scheduled with corresponding RA-RNTI/MSGB-RNTI is the same as that of the CORESET associated with reception/detection of the PDCCH order.
(5) UE determines that DM-RS port QCL properties of the PDCCH scrambled by the corresponding RA-RNTI/MSGB-RNTI is the same as that of a downlink reference signal associated with a TCI state corresponds to the transmission parameter (e.g., CORESET pool) indicated by the PDCCH order. In some embodiments, the TCI state can be the TCI state with the lowest TCI state index among TCI states correspond to the transmission parameter. In some embodiments, the TCI state can be a TCI state associated with the CORESET with the lowest CORESET index correspond to the transmission parameter.

In embodiments above, the Type1-PDCCH CSS set is configured for detecting/receiving PDCCH scrambled by RA-RNTI/MSGB-RNTI in response to PRACH transmission associated with a transmission parameter, wherein the transmission parameter can be associated with the information/identity of transmission parameter for detecting/receiving the PDCCH order or the information/identity of transmission parameter indicated by the PDCCH order.

### II. (c) Example Embodiment 3

Embodiment 3 describes example techniques for a UE to determine transmission power of PRACH transmission in response to a random access procedure triggered by a PDCCH order.

In some embodiments, UE reports or is configured/indicated to not receive random access response in response to a PRACH transmission associated with a transmission parameter. UE does not to detect PDCCH scrambled by RA-RNTI/MSGB-RNTI or not to receive RAR in response to the PRACH transmission.

In some embodiments, if the random access preamble associated with a transmission parameter is transmitted by the MAC entity of the UE, wherein the transmission parameter is configured/indicated to not receive RAR, then at least one of the following may be performed by the UE: the corresponding random access procedure is considered completed, MAC entity does not start the random access response window, or MAC entity does not monitor PDCCH for random access response identified by the corresponding RA-RNTI/MSGB-RNTI. In one example, the UE is indicated to not receive RAR by receiving a DCI format or a MAC CE that may include a field that includes an identity or an index of a transmission parameter, where the field indicates that the UE is not to receive the RAR associated with the transmission parameter.

In some embodiments, if a random access procedure associated with a transmission parameter triggered by a PDCCH order is ongoing/running/uncompleted, and UE receives another PDCCH order triggering random access procedure associated with the same transmission parameter, UE considers the random access procedure associated with the transmission parameter is to be re-triggered, and the ongoing random access procedure is considered completed, and UE initiates a random access procedure based on the second received PDCCH order. In some embodiments, the PDCCH order and the another PDCCH order indicates the same information/identity of a transmission parameter. In some embodiments, the PDCCH order and the another PDCCH order further indicates the same of at least one of: random access preamble index, PRACH mask index or SSB index.

In some embodiments, UE receives a PDCCH order to initiate random access procedure associated with a transmission parameter and a random access procedure associated with the same transmission parameter triggered by a (n) earlier/former received PDCCH order is ongoing/running/uncompleted, UE determines to adjust PRACH received target power or PRACH transmission power for the PRACH transmission in response to the initiated random access procedure.

UE adjusting PRACH received target power (e.g., the open loop power control parameter configured for PRACH transmission) or PRACH transmission power for a PRACH transmission is based on a RRC-configured preamble received target power, pathloss calculated based on a DL-RS associated with the random access procedure, and an adjustment value of transmission power, wherein the adjustment value of transmission power is determined based on at least one of:
(1) The adjustment value of transmission power is fixed/predefined.
(2) The adjustment value of transmission power is configured for the transmission parameter in RRC messages.
(3) The adjustment value of transmission power is indicated in an indication field of the PDCCH order associated with the PRACH transmission, e.g., an absolute TPC command field.
(4) The adjustment value of transmission power is determined based on the adjustment value of transmission power for another PRACH transmission triggered by the former PDCCH order and an indication field of the PDCCH order corresponds to the PRACH transmission. In one example, if the indication field indicates a transmission power adjustment value of X dB, and the adjustment value of transmission power for the PRACH transmission triggered by the former PDCCH order is Y dB, the adjustment value of transmission power for the PRACH transmission triggered by the PDCCH order is (X+Y) dB.
(5) The adjustment value of transmission power is based on a fixed/predefined/configured power adjustment parameter and an indication field of the PDCCH order associated with the PRACH transmission.
   The indication field indicative of a counting indication, if the indication field is absent or indicates a value of 0, the adjustment value of transmission power equals to 0, otherwise the adjustment value of transmission power is determined based on the indication filed and the power adjustment parameter. In one example, if the indication field indicates a value of X and the power adjustment parameter is configured to be Y dB, the adjustment value of transmission power is X*Y dB.
   The indication field indicative of a flag/toggle with one-bit, if the value of the indication field in the latter one received PDCCH order is the same as that in the former one received PDCCH order, adjustment value of transmission power is the same as that for the PRACH transmission triggered by the former received PDCCH order, otherwise, adjustment value of transmission power is determined based on the adjustment value of transmission power for the PRACH transmission triggered by the former received PDCCH order and the power adjustment parameter. In one example, power adjustment parameter is configured to be X dB, if the value of indication field of the first PDCCH order and second PDCCH order is 0 and 1 respectively, and adjustment value of transmission power for the PRACH transmission triggered by the first PDCCH order is Y dB, adjustment value of transmission power for the PRACH transmission triggered by the second PDCCH order is (X+Y) dB.
(6) The adjustment value of transmission power is based on a fixed/predefined/configured power adjustment parameter and a value counted by UE for PDCCH order/random access procedure associated with a transmission parameter. In one example, power adjustment parameter is configured to be X dB, if UE receives 3 PDCCH order triggering random access procedure associated with the same transmission parameter, the adjustment value of transmission power for respective PRACH transmission is 0 dB, X dB and 2*X dB accordingly. The counting value is 0, 1 and 2 respectively.

In embodiments above, if PRACH transmission associated with a transmission parameter triggered by a PDCCH order is in response to a random access procedure initiated for the transmission parameter for the first time, or initiated for the transmission parameter separate from the former initiated random access procedures, the adjustment value of transmission power is not needed or the adjustment value of transmission power is 0.

### II. (d) Example Embodiment 4

Embodiment 4 describes example techniques to specify indication fields of messages from base station side in response to random access procedures or related to the event requesting random access procedures.

In some embodiments, after PRACH transmissions associated with transmission parameter(s) or completion of random access procedure(s) associated with transmission parameter(s), UE receives a cell switch command message indicative of switching towards a new transmission parameter, where the cell switch command message may include the information/identity of the new transmission parameter.

In some embodiments, UE receives a cell switch command message including an indication field indicative of an information of C-RNTI,
if the indication field explicitly indicates a C-RNTI or a TC-RNTI, UE applies the indicated C-RNTI/TC-RNTI to uplink and downlink transmissions.
if the indication field indicates an offset value of C-RNTI, UE determines a C-RNTI to be applied to uplink and downlink transmissions based on the current C-RNTI and the offset value.

In some embodiments, UE is configured the association between a C-RNTI and a transmission parameter. UE receives a cell switch command message including a field of information/identity of a transmission parameter,
if the association between a C-RNTI and the transmission parameter is not configured, UE does not to update/change/replace the C-RNTI.
if the association between a C-RNTI and the transmission parameter is configured, UE applies the C-RNTI associated with the transmission parameter to uplink and downlink transmissions.

In some embodiments, UE receives a random access response in response to a PRACH transmission associated with a transmission parameter, wherein the transmission parameter can be a candidate cell, a CORESETPool with coresetpoolindex=1, an additional PCI, or a RACH configuration configured not for serving cell. At least one of the following is considered by UE.
The UL grant field is reserved.
The Temporary C-RNTI field indicates a C-RNTI associated with the transmission parameter. After UE receives a cell switch command message indicative of an information/identity of the transmission parameter, the C-RNTI is used for UE.
The Temporary C-RNTI field indicates a C-RNTI index. UE is configured a set/pool/list of C-RNTI for a transmission parameter, or a set/pool/list of combination/mapping/association of a C-RNTI and a transmission parameter. The C-RNTI index is mapped to a C-RNTI for a transmission parameter or is mapped to a combination/mapping/association of a C-RNTI and a transmission parameter.
The Temporary C-RNTI field is absent and another indication field indicative of a C-RNTI or a C-RNTI index. The C-RNTI index is mapped to a C-RNTI for a transmission parameter or is mapped to a combination/mapping/association of a C-RNTI and a transmission parameter.

### II. (e) Example Embodiment 5

Embodiment 5 describes example techniques for a UE to memorize (or store) or maintain or restore TA value(s) in response to UE reporting a UE capability of the maximum number of memorized TA values.

In some embodiments, UE initiates a random access procedure associated with a transmission parameter, and receives a random access response at least including a timing advance related message. The UE may memorize or store one TA value per transmission parameter (e.g., per TRP, per cell or per TAG).
If the timing advance related message is associated with a transmission parameter for which the UE determines that it has already stored or memorized a timing advance (TA) value or for which the UE determines that the random access procedure has already been initiated/completed, UE determines a new TA value based on the received timing advance related message and updates the TA value associated with the transmission parameter.
If the timing advance related message is associated with a transmission parameter for which the UE determines that it has not stored or memorized a TA value or for which the UE determines that the random access procedure has not been initiated, and if the UE determines that memorizing or storing the TA value will not exceed the UE's capability (or the total number of TA values to be stored by the UE), then the UE determines the TA value based on the received timing advance related message and memorizes or stores the TA value associated with the transmission parameter.
If the TA related message is associated with a transmission parameter for which the UE determines that it has not stored or memorized a TA value or for which the UE determines that the random access procedure has not been initiated, and if the UE determines that a total number of memorized or stored TA values equals the UE's capability (or the total number of TA values to be stored by the UE), then the UE drops/deletes/invalidates/clears a most remotely/earliest memorized TA value associated with another transmission parameter, and the UE determines the TA value based on the received timing advance related message and memorizes or stores the TA value associated with the transmission parameter.

In some embodiments, UE receives a transmission parameter activation MAC CE wherein a plurality of transmission parameters are mapped/included/indicated. The total number of transmission parameters or the number of unique transmission parameters in the MAC CE is not greater than the UE capability of the maximum number of memorized TA values. UE does not initiate random access procedures and/or maintain timing advance values associated with the transmission parameters not included in the MAC CE.

In some embodiments, the transmission parameters included in different transmission parameter activation MAC CE are all considered as activated transmission parameters. In some embodiments, only the transmission parameters included in the recent received activation MAC CE is considered activated. UE initiates random access procedures and/or maintain timing advance values associated with the activated transmission parameters.

In some embodiments, UE receives a transmission parameter deactivation MAC CE wherein a plurality of transmission parameters are mapped/included/indicated. UE drops the memorized timing advance values associated with the transmission parameters included in the MAC CE.

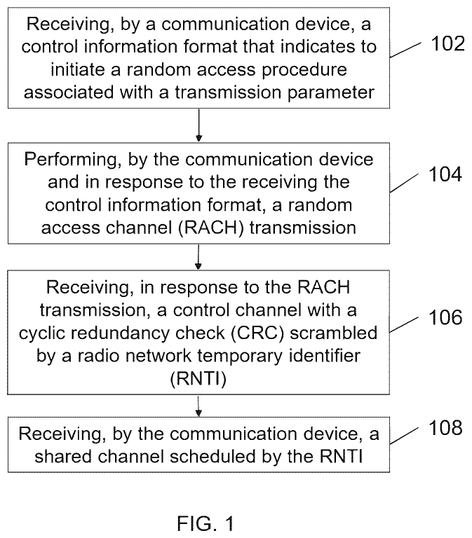

FIG. 1 shows an example flowchart for defining or determining a random access response window. Operation 102 includes receiving, by a communication device, a control information format that indicates to initiate a random access procedure associated with a transmission parameter. Operation 104 includes performing, by the communication device and in response to the receiving the control information format, a random access channel (RACH) transmission. Operation 106 includes receiving, in response to the RACH transmission, a control channel with a cyclic redundancy check (CRC) scrambled by a radio network temporary identifier (RNTI), where the RNTI is associated with the RACH transmission. Operation 108 includes receiving, by the communication device, a shared channel scheduled by the RNTI, where the control channel and the shared channel are received during a random access response window that is defined according to a rule.

In some embodiments, the rule specifies that the random access response window starts at a symbol based on any one or more of: (1) a first symbol of an earliest control resource set (CORESET) that the communication device is configured to receive the control channel for a Type1-PDCCH common search space (CSS) set, where the Type1-PDCCH CSS set is configured for a serving cell or for the transmission parameter, (2) an offset value for the transmission parameter, where the offset value indicates a number of symbols or a number of slots, (3) an indication field of the control information format for a physical downlink control channel (PDCCH) order that triggers the random access procedure, where the indication field indicates a number of milliseconds, a number of symbols, or a number of slots, or (4) a first symbol or a last symbol of the RACH transmission. In some embodiments, the rule specifies that a length of the random access response window is based on any one or more of: (1) another length of the random access response window configured for a serving cell or for a corresponding transmission parameter, (2) an offset value for the transmission parameter, where the offset value indicates a number of milliseconds, (3) an indication field of the control information format for a physical downlink control channel (PDCCH) order that triggers the random access procedure, where the indication field indicates a number of milliseconds.

In some embodiments, the rule specifies that the random access response window is based on: a configured set of values or a combination of values associated with a starting point of the random access response window and/or a length of the random access response window, where the configured set of values are configured by a radio resource control (RRC) message, a codepoint of an indication field of the control information format for a physical downlink control channel (PDCCH) order that triggers the random access procedure, where the codepoint is mapped to a value or a combination of values within the configured set of values. In some embodiments, the control information format includes a downlink control information (DCI) format, where the control channel is a physical downlink control channel (PDCCH), and where the shared channel is a physical downlink shared channel (PDSCH).

In some embodiments, the method further comprises receiving, by the communication device, a physical downlink control channel (PDCCH) order associated with a first transmission parameter using a first quasi co-location (QCL) property of a reference signal port; receiving, by the communication device, a channel using a second QCL property of the reference signal port in response to at least one of: (1) a first information or a first identity of the first transmission parameter to receive the PDCCH order being different than a second information or a second identity of a second transmission parameter indicated by an indication field in the PDCCH order, or (2) the first information or the first identity of the first transmission parameter to receive the PDCCH order being different than a third information or a third identity of the transmission parameter to receive the channel. In some embodiments, the second QCL property of the reference signal port to receive the channel is same as that of a synchronized signal block (SSB) or a channel state information reference signal (CSI-RS) used for the performing the RACH transmission, and where the channel is a physical downlink control channel (PDCCH) scrambled with the RNTI, or the channel is a physical downlink shared channel (PDSCH) scheduled with the RNTI.

In some embodiments, the second QCL property of the reference signal port to receive the channel is same as that of a control resource set (CORESET) associated with a Type-1 physical downlink control channel (PDCCH) common search space (CSS) set, and where the channel is a physical downlink control channel (PDCCH) scrambled with the RNTI. In some embodiments, the second QCL property of the reference signal port to receive the channel is same as that of a physical downlink control channel (PDCCH) scrambled with the RNTI, and where the channel is a physical downlink shared channel (PDSCH) scheduled with the RNTI. In some embodiments, the reference signal port includes a demodulation reference signal (DM-RS) port. In some embodiments, the method further comprises receiving, by the communication device, a physical downlink control channel (PDCCH) order associated with a first transmission parameter using a first quasi co-location (QCL) property of a reference signal port; receiving, by the communication device, a channel using a second QCL property of the reference signal port in response to at least one of: (1) a first information or a first identity of the first transmission parameter to receive the PDCCH order being different than a second information or a second identity of a second transmission parameter indicated by an indication field in the PDCCH order, or (2) the first information or the first identity of the first transmission parameter to receive the PDCCH order being same as a third information or a third identity of the transmission parameter to receive the channel.

In some embodiments, the second QCL property of the reference signal port to receive the channel is same as that of a control resource set (CORESET) associated with a Type-1 physical downlink control channel (PDCCH) common search space (CSS) set, and where the channel is a physical downlink control channel (PDCCH) scrambled with the RNTI. In some embodiments, the second QCL property of the reference signal port to receive the channel is same as that of a physical downlink control channel (PDCCH) scrambled with the RNTI, and where the channel is a physical downlink shared channel (PDSCH) scheduled with the RNTI. In some embodiments, the second QCL property of the reference signal port to receive the channel is same as that of a control resource set (CORESET) associated with the receiving the PDCCH order, and where the channel is a physical downlink shared channel (PDSCH) scrambled with the RNTI.

In some embodiments, the reference signal port includes a demodulation reference signal (DM-RS) port. In some embodiments, the method further comprises receiving, by the communication device, a configuration or an indication to receive or not to receive a random access response (RAR); and performing, in response to the receiving the configuration or the indication, any one or more of following operations: a random access procedure in response to a transmission of a random access preamble is determined to be completed, the random access response window is not started by a medium access control (MAC) entity of the communication device, or a physical downlink control channel (PDCCH) is not monitored by the MAC entity for the RAR identified by a corresponding RNTI.

In some embodiments, the method further comprises adjusting, in response to the receiving the control information format that indicates to initiate the random access procedure, a random access channel (RACH) target received power or a power with which the RACH transmission is performed during the random access procedure, where the adjusting is performed based on at least one of: (1) a fixed power adjustment parameter, a predefined power adjustment parameter, or a configured power adjustment parameter, or (2) an indication field included in the control information format, where the indication field indicates a counting indication, a toggle flag or a power control command. In some embodiments, further comprises receiving, by the communication device, a cell switch command message or a random access response (RAR) that includes an indication field indicative of a second RNTI; and performing, by the communication device, a transmission or a reception by: applying the second RNTI that is indicated in the indication field, applying the second RNTI based on an offset value indicated in the indication field, where the offset value is related to the second RNTI, or applying the second RNTI associated with the transmission parameter indicated in the indication field.

In some embodiments, configuration related to an association between the second RNTI and the transmission parameter is received by the communication device. In some embodiments, the second RNTI is a cell radio network temporary identifier (C-RNTI) or a temporary cell radio network temporary identifier (TC-RNTI). In some embodiments, the method further comprises receiving, by the communication device, a timing advance related message that is associated with the transmission parameter based on a reception of a random access response (RAR); determining, by the communication device, a timing advance (TA) value associated with the transmission parameter. In some embodiments, the method further comprises receiving, by the communication device, a medium access control-control element (MAC CE) that indicates a plurality of transmission parameters, where a first total number of the plurality of transmission parameters or a second total number of one or more unique transmission parameters in the plurality of transmission parameters is less than or equal to a total number of TA values that the communication device is capable of storing; and storing, by the communication device, the TA value associated with the transmission parameters indicated by the MAC CE.

In some embodiments, the method further comprises receiving, by the communication device, a deactivation medium access control-control element (MAC CE) that indicates one or more transmission parameters to be deactivated; and deleting, in response to the receiving the deactivation MAC CE, one or more TA values associated with the one or more transmission parameters. In some embodiments, the method further comprises performing TA related operations in response to: a number of TA values stored in the communication device being equal to a total number of TA values that the communication device is capable of storing, and a timing advance (TA) value for the transmission parameter is not stored by the communication device, where the TA related operations includes: deleting a second TA value stored in the communication device at an earliest time relative to one or more other TA values stored in the communication device; and storing, after the deleting, the TA value.

In some embodiments, the transmission parameter comprises any one or more of: information grouping one or more reference signals, a reference signal resource set, a physical uplink control channel (PUCCH) resource set, a search space, a panel related information, a sub-array, an antenna group, an antenna port group, a group of antenna ports, a beam group, a physical cell index (PCI), a transmit-receive point (TRP) related information, a control resource set (CORESET), a CORESET pool, a transmission configuration indicator (TCI) state, a serving cell, an additional PCI, a candidate cell, a candidate cell group, a timing advance group (TAG), a UE capability value, or a UE capability set.

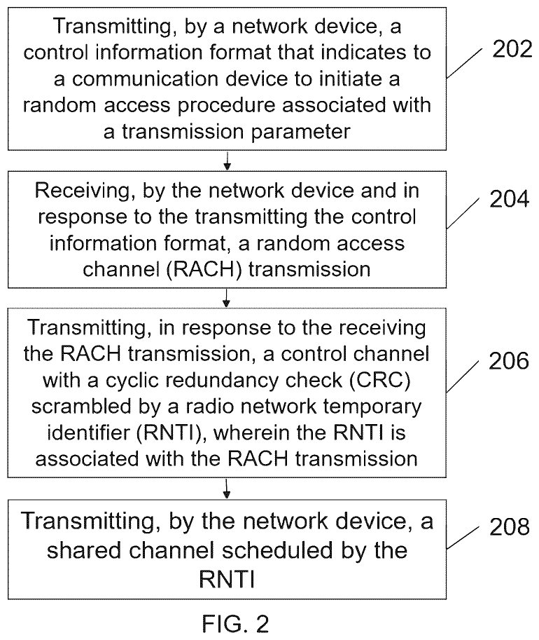

FIG. 2 shows an example flowchart for transmitting channel(s) during a random access procedure. Operation 202 includes transmitting, by a network device, a control information format that indicates to a communication device to initiate a random access procedure associated with a transmission parameter. Operation 204 includes receiving, by the network device and in response to the transmitting the control information format, a random access channel (RACH) transmission. Operation 206 includes transmitting, in response to the receiving the RACH transmission, a control channel with a cyclic redundancy check (CRC) scrambled by a radio network temporary identifier (RNTI), where the RNTI is associated with the RACH transmission. Operation 208 includes transmitting, by the network device, a shared channel scheduled by the RNTI.

In some embodiments, the control information format includes an indication field to indicate to the communication device to adjust a random access channel (RACH) target received power or a power with which the RACH transmission is performed during the random access procedure, where the indication field indicates a counting indication, a toggle flag or a power control command. In some embodiments, the method further comprises transmitting, by the network device, a cell switch command message or a random access response (RAR) that includes an indication field indicative of a second RNTI. In some embodiments, configuration related to an association between the second RNTI and the transmission parameter is transmitted by the network device. In some embodiments, the second RNTI is a cell radio network temporary identifier (C-RNTI) or a temporary cell radio network temporary identifier (TC-RNTI).

In some embodiments, the method further comprises transmitting, by the network device, a timing advance related message that is associated with the transmission parameter based on a transmission of a random access response (RAR). In some embodiments, the method further comprises transmitting, by the network device, a medium access control-control element (MAC CE) that indicates a plurality of transmission parameters, where a first total number of the plurality of transmission parameters or a second total number of one or more unique transmission parameters in the plurality of transmission parameters is less than or equal to a total number of TA values that the communication device is capable of storing. In some embodiments, the method further comprises transmitting, by the network device, a deactivation medium access control-control element (MAC CE) that indicates one or more transmission parameters to be deactivated. In some embodiments, the transmission parameter comprises any one or more of: information grouping one or more reference signals, a reference signal resource set, a physical uplink control channel (PUCCH) resource set, a search space, a panel related information, a sub-array, an antenna group, an antenna port group, a group of antenna ports, a beam group, a physical cell index (PCI), a transmit-receive point (TRP) related information, a control resource set (CORESET), a CORESET pool, a transmission configuration indicator (TCI) state, a serving cell, an additional PCI, a candidate cell, a candidate cell group, a timing advance group (TAG), a UE capability value, or a UE capability set.

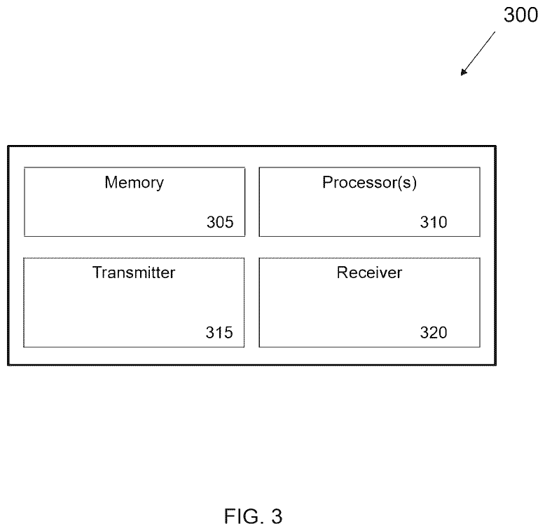

FIG. 3 shows an exemplary block diagram of a hardware platform 300 that may be a part of a network device (e.g., base station) or a communication device (e.g., a user equipment (UE)). The hardware platform 300 includes at least one processor 310 and a memory 305 having instructions stored thereupon. The instructions upon execution by the processor 310 configure the hardware platform 500 to perform the operations described in FIGS. 1 to 2 and in the various embodiments described in this patent document. The transmitter 315 transmits or sends information or data to another device. For example, a network device transmitter can send a message to a user equipment. The receiver 320 receives information or data transmitted or sent by another device. For example, a user equipment can receive a message from a network device.

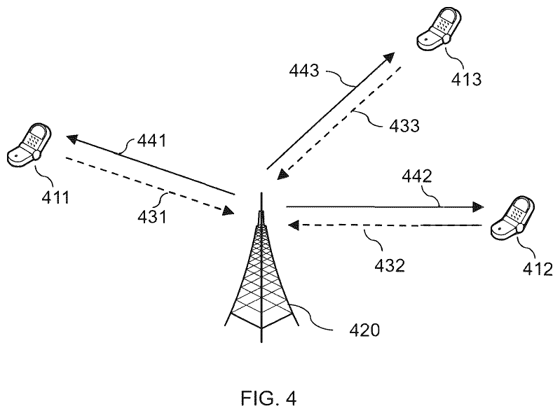

The implementations as discussed above will apply to a wireless communication. FIG. 4 shows an example of a wireless communication system (e.g., a 5G or NR cellular network) that includes a base station 420 and one or more user equipment (UE) 411, 412 and 413. In some embodiments, the UEs access the BS (e.g., the network) using a communication link to the network (sometimes called uplink direction, as depicted by dashed arrows 431, 432, 433), which then enables subsequent communication (e.g., shown in the direction from the network to the UEs, sometimes called downlink direction, shown by arrows 441, 442, 443) from the BS to the UEs. In some embodiments, the BS send information to the UEs (sometimes called downlink direction, as depicted by arrows 441, 442, 443), which then enables subsequent communication (e.g., shown in the direction from the UEs to the BS, sometimes called uplink direction, shown by dashed arrows 431, 432, 433) from the UEs to the BS. The UE may be, for example, a smartphone, a tablet, a mobile computer, a machine to machine (M2M) device, an Internet of Things (IoT) device, and so on.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A wireless communication method, comprising:
receiving, by a communication device, a control information format that is associated with a first physical cell index (PCI) and that indicates a physical downlink control channel (PDCCH) order to initiate a random access procedure associated with a second PCI;
performing, by the communication device and in response to the receiving the control information format, a random access channel (RACH) transmission;
receiving, in response to the RACH transmission, a control channel with a cyclic redundancy check (CRC) scrambled by a radio network temporary identifier (RNTI),
wherein the RNTI is associated with the RACH transmission,
wherein the control channel with the CRC scrambled by the RNTI is received using a first quasi co-location (QCL) property of a reference signal port,
wherein the first QCL property of the reference signal port is same as that of a control resource set (CORESET) associated with a Type-1 physical downlink control channel (PDCCH) common search space (CSS) set; and
receiving, by the communication device, a shared channel scheduled by the RNTI,
wherein the control channel and the shared channel are received during a random access response window,
wherein the random access response window starts at a first symbol of an earliest CORESET that the communication device is configured to receive the control channel associated with the Type-1 PDCCH CSS set, and
wherein the Type-1 PDCCH CSS set is configured for a serving cell.

2. The method of claim 1, wherein the communication device receives the control information format using a second QCL property of the reference signal port.

3. The method of claim 1, wherein the control information format includes a downlink control information (DCI) format, wherein the control channel is a physical downlink control channel (PDCCH), and wherein the shared channel is a physical downlink shared channel (PDSCH).

4. The method of claim 1, wherein the shared channel scheduled by the RNTI is received using the first QCL property of the reference signal port.

5. The method of claim 1, wherein the reference signal port includes a demodulation reference signal (DM-RS) port.

6. The method of claim 1, wherein further comprising:
receiving, by the communication device, a timing advance related message based on a reception of a random access response (RAR),
wherein the timing advance related message indicates a time alignment group (TAG) index.

7. The method of 1, wherein the PDCCH order indicates an identity of the second PCI.

8. An apparatus for wireless communication comprising one or more processors, configured to cause the apparatus to:
receive, by a communication device, a control information format that is associated with a first physical cell index (PCI) and that indicates a physical downlink control channel (PDCCH) order to initiate a random access procedure associated with a second PCI;
perform, by the communication device and in response to the receive the control information format, a random access channel (RACH) transmission;
receive, in response to the RACH transmission, a control channel with a cyclic redundancy check (CRC) scrambled by a radio network temporary identifier (RNTI),
wherein the RNTI is associated with the RACH transmission,
wherein the control channel with the CRC scrambled by the RNTI is received using a first quasi co-location (QCL) property of a reference signal port,
wherein the first QCL property of the reference signal port is same as that of a control resource set (CORESET) associated with a Type-1 physical downlink control channel (PDCCH) common search space (CSS) set; and
receive, by the communication device, a shared channel scheduled by the RNTI,
wherein the control channel and the shared channel are received during a random access response window,
wherein the random access response window starts at a first symbol of an earliest CORESET that the communication device is configured to receive the control channel associated with the Type-1 PDCCH CSS set, and
wherein the Type-1 PDCCH CSS set is configured for a serving cell.

9. The apparatus of claim 8, wherein the communication device receives the control information format using a second QCL property of the reference signal port.

10. The apparatus of claim 8, wherein the control information format includes a downlink control information (DCI) format, wherein the control channel is a physical downlink control channel (PDCCH), and wherein the shared channel is a physical downlink shared channel (PDSCH).

11. The apparatus of claim 8, wherein the shared channel scheduled by the RNTI is received using the first QCL property of the reference signal port.

12. The apparatus of claim 8, wherein the reference signal port includes a demodulation reference signal (DM-RS) port.

13. The apparatus of claim 8, wherein the one or more processors further configure the apparatus to:
receive, by the communication device, a timing advance related message based on a reception of a random access response (RAR),
wherein the timing advance related message indicates a time alignment group (TAG) index.

14. The apparatus of claim 8, wherein the PDCCH order indicates an identity of the second PCI.

15. A non-transitory computer readable program storage medium having code stored thereon, the code, when executed by one or more processors, causing an apparatus to implement a method, comprising:
receiving, by a communication device, a control information format that is associated with a first physical cell index (PCI) and that indicates a physical downlink control channel (PDCCH) order to initiate a random access procedure associated with a second PCI;
performing, by the communication device and in response to the receiving the control information format, a random access channel (RACH) transmission;
receiving, in response to the RACH transmission, a control channel with a cyclic redundancy check (CRC) scrambled by a radio network temporary identifier (RNTI),
wherein the RNTI is associated with the RACH transmission,
wherein the control channel with the CRC scrambled by the RNTI is received using a first quasi co-location (QCL) property of a reference signal port,
wherein the first QCL property of the reference signal port is same as that of a control resource set (CORESET) associated with a Type-1 physical downlink control channel (PDCCH) common search space (CSS) set; and
receiving, by the communication device, a shared channel scheduled by the RNTI,
wherein the control channel and the shared channel are received during a random access response window,
wherein the random access response window starts at a first symbol of an earliest CORESET that the communication device is configured to receive the control channel associated with the Type-1 PDCCH CSS set, and
wherein the Type-1 PDCCH CSS set is configured for a serving cell.

16. The non-transitory computer readable program storage medium of claim 15, wherein the communication device receives the control information format using a second QCL property of the reference signal port.

17. The non-transitory computer readable program storage medium of claim 15, wherein the control information format includes a downlink control information (DCI) format, wherein the control channel is a physical downlink control channel (PDCCH), and wherein the shared channel is a physical downlink shared channel (PDSCH).

18. The non-transitory computer readable program storage medium of claim 15, wherein the shared channel scheduled by the RNTI is received using the first QCL property of the reference signal port.

19. The non-transitory computer readable program storage medium of claim 15, wherein the reference signal port includes a demodulation reference signal (DM-RS) port.

20. The non-transitory computer readable program storage medium of claim 15, wherein the method further comprises:
receiving, by the communication device, a timing advance related message based on a reception of a random access response (RAR),
wherein the timing advance related message indicates a time alignment group (TAG) index.
